(19) United States
(12) Patent Application Publication
(10) Pub. No.: US 2025/0214911 A1
(43) Pub. Date: Jul. 3, 2025

(54) CASTOR BIOLOGICAL FERTILIZER ADDED WITH FERMENTATION BACTERIA AND SOIL ACTIVE ENZYMES

(71) Applicant: Inner Mongolia Minzu University, Tongliao (CN)

(72) Inventors: Fenglan HUANG, Tongliao (CN); Mingjing LI, Tongliao (CN); Rui LUO, Tongliao (CN); Guorui LI, Tongliao (CN); Jianjun DI, Tongliao (CN); Huayang ZHAO, Tongliao (CN); Cheng WANG, Tongliao (CN); Zhibiao HE, Tongliao (CN); Hongxiang QIU, Tongliao (CN); Jinglong ZHANG, Tongliao (CN)

(21) Appl. No.: 18/921,518

(22) Filed: Oct. 21, 2024

(30) Foreign Application Priority Data
Dec. 27, 2023 (CN) 202311818197.5

(51) Int. Cl. C05F 17/20; C05F 5/00

(52) U.S. Cl. CPC C05F 17/20; C05F 5/002

(57) ABSTRACT

Disclosed are an organic fertilizer of normal-temperature cold-pressed castor bean meal fermented by microbial inoculants, a preparation method and an application thereof, belonging to the technical field of fertilizers. The preparation method includes: S1, preparing normal-temperature cold-pressed castor bean meal; S2, preparing a fermentation microbial inoculant package, where microbial inoculants, enzymes and a culture substrate for activating fermentation microbial inoculants are added into the packaging bag of the microbial inoculant package according to a certain ratio to obtain the fermentation microbial inoculant package; and S3, fermenting the normal-temperature cold-pressed castor bean meal.

### CROSS-REFERENCE TO RELATED APPLICATIONS

This application claims priority to Chinese Patent Application No. 202311818197.5, filed on Dec. 27, 2023, the contents of which are hereby incorporated by reference.

### TECHNICAL FIELD

The present disclosure relates to the technical field of fertilizers, and in particular to an organic fertilizer of normal-temperature cold-pressed castor bean meal fermented by microbial inoculants, a preparation method and an application thereof.

### BACKGROUND

The currently used method for preparing castor (Ricinus communis) bean meal is hot pressing, which provides a high rate of oil extraction from castor seeds, but is inferior in the following aspects: firstly, the castor bean meal prepared at a temperature of 100 degrees Celsius (C) or above is low in nutrient content, with the oil content of the meal being particularly low; besides, the natural insecticide components are destroyed at high temperatures; the castor bean meal contains extraneous solvent oils that may contaminate the soil when applied as fertilizer; moreover, the castor bean meal is poorly packaged and prone to spoilage. In addition to hot pressing, researchers have also been used the method of cold pressing to obtain castor bean meal, and the prepared castor oil has an improved quality as compared to that of castor oil obtained by the method of hot pressing, i.e., the crude fat content of the prepared castor bean meal is slightly increased and the natural pesticide content is not destroyed; however, the solvent oil is still included.

The castor bean meal is obtained by oil extraction, whereas the utilization rate of crop absorption is low if the meal is directly applied to the farmland. After microbial fermentation and decomposition, the protein of large molecule in the castor bean meal is decomposed into polypeptides and free amino acids, which are easy to be absorbed and utilized by the crop. Therefore, it is required to prepare castor bean meal into castor bean meal fertilizer, which is generally obtained by composting; however, the existing composting method involves no auxiliary fermentation bacteria, and also has no enzyme added to improve the soil, as a result, the prepared castor bean meal fertilizer is of low efficacy.

### SUMMARY

The present disclosure provides an organic fertilizer of normal-temperature cold-pressed castor bean meal fermented by microbial inoculants, a preparation method and an application thereof. The prepared organic fertilizer has higher nutritional value, longer shelf life, shorter fermentation duration and better soil improvement effect, in addition to no pollution to the soil, and it is more conducive to the development of green, organic and ecological agriculture.

In order to achieve the above objectives, the present disclosure provides a preparation method of an organic fertilizer of normal-temperature cold-pressed castor bean meal fermented by microbial inoculants, including following steps:
S1, preparing normal-temperature cold-pressed castor bean meal:
S11, pre-squeezing stage: setting a temperature of a spiral oil press at 180-200 degrees Celsius (° C.), adding castor seeds to a feed port, adjusting a flow rate of feeding the castor seeds with a vibrating amplitude of 12-14, adjusting a thickness of the castor bean meal to be 0.8-1.2 millimeters (mm), and carrying out a pre-pressing until the oil press operates normally, then turning off a heating setting of the oil press, allowing the temperature of the oil press to be gradually reduced to 20-30° C.;
S12, normal-temperature cold pressing stage: adding castor seeds into the feed port at normal temperature, and directly squeezing oil to obtain the normal-temperature cold-pressed castor bean meal;
S13, packaging: stirring and crushing an obtained normal-temperature cold-pressed castor bean meal by using a stirrer, followed by putting into a packaging bag, beating into a rice brick shape and performing vacuum-packaging;
S2, preparing a fermentation microbial inoculant package, where microbial inoculants, enzymes and a culture substrate for activating fermentation microbial inoculants are added into the packaging bag of the microbial inoculant package according to a ratio of 25-30:22-26:194-202 to obtain the fermentation microbial inoculant package;
S3, fermenting the normal-temperature cold-pressed castor bean meal:
S31, activating the fermentation microbial inoculants: cutting open the fermentation microbial inoculant package, adding water, mixing and stirring to form a dough with no water outflows from the dough, and standing at normal temperature for 2-3 h to activate the fermentation microbial inoculants;
S32, fermentation: cutting open one end of a vacuum packaging bag of the normal-temperature cold-pressed castor bean meal, adding activated fermentation microbial inoculants into the castor bean meal, adding water, stirring and mixing until the bean meal is in a dough, and no water flows out of the dough; sealing the packaging bag of the bean meal, and fermenting in an environment with a temperature of 20-30° C.;
among them, in step S32, a ratio of the normal-temperature cold-pressed castor bean meal: fermentation microbial inoculants: water is 4-5 kilograms (kg): 250-300 g: 800-1000 milliliters (mL).

Optionally, in step S2, the microbial inoculants include Bacillus, Saccharomycese, photosynthetic bacteria, acetic acid bacteria, lactic acid bacteria, actinomyces and Trichoderma, and a mass ratio is 1:1:1:1:1:1:1.

Optionally, in the step S2, the enzymes include soil urease, protease, phosphatase, sucrase, catalase, polyphenol oxidase, cellulase and acid invertase in a mass ratio of 1:1:1:1:1:1:1:1.

Optionally, in the step S2, the culture substrate for activating the fermentation microbial inoculants is corn flour.

Optionally, in step S3, a fermentation duration is 20-30 days (d), with piles being turned over at intervals of 7 d.

The present disclosure also provides an organic fertilizer of normal-temperature cold-pressed castor bean meal fermented by microbial inoculants prepared by the preparation method of the organic fertilizer of normal-temperature cold-pressed castor bean meal fermented by microbial inoculants.

The present disclosure also provides an application of the organic fertilizer of normal-temperature cold-pressed castor bean meal fermented by microbial inoculants in economic plants, and a consumption of the organic fertilizer of normal-temperature cold-pressed castor bean meal fermented by microbial inoculants is 2500 kilograms per hektare (kg·ha⁻¹)−1 ton per hektare (t·ha⁻¹).

Accordingly, by adopting the organic fertilizer of normal-temperature cold-pressed castor bean meal fermented by microbial inoculants, the preparation method and the application thereof of the present disclosure may achieve the following technical effects.

The castor bean meal prepared at normal temperature has relatively high content of nutrients, especially oil; under normal temperature, the components of natural pesticides are not destroyed, and there is no additional solvent oil added in the castor bean meal, and the soil will not be polluted when fertilizing; the castor bean meal is vacuum packaged into rice brick shape, which contributes greatly to the shelf-life and facilitates storage and transportation.

The prepared castor bean meal is packed into rice bricks in vacuum, which may prolong the shelf life on the one hand and facilitate storage and transportation on the other.

When the castor bean meal is used to prepare fertilizer, the castor bean meal is fermented by microbial inoculants prepared by various compound fermenting bacteria. Compared with the conventional natural fermentation method, the preparation of castor bean meal fertilizer with other bacterial fermentation, a variety of composite fermentation bacteria are added, and the type of bacteria is different from other methods, as well as more types of bacteria; in addition to the fermentation bacteria, enzymes that are conducive to improving the soil are also added. In this way, the castor bean meal is better fermented, the time needed for fermentation is shorter, and the effect of soil improvement is more significant.

The technical schemes of the present disclosure are further described in detail through the attached drawings and embodiments.

### BRIEF DESCRIPTION OF THE DRAWINGS

FIG. 1 is a flow chart illustrating a preparation method of an organic fertilizer of normal-temperature cold-pressed castor bean meal fermented by microbial inoculants.

FIG. 2 is a flow chart illustrating S1 of the preparation method of the organic fertilizer of normal-temperature cold-pressed castor bean meal fermented by microbial inoculants.

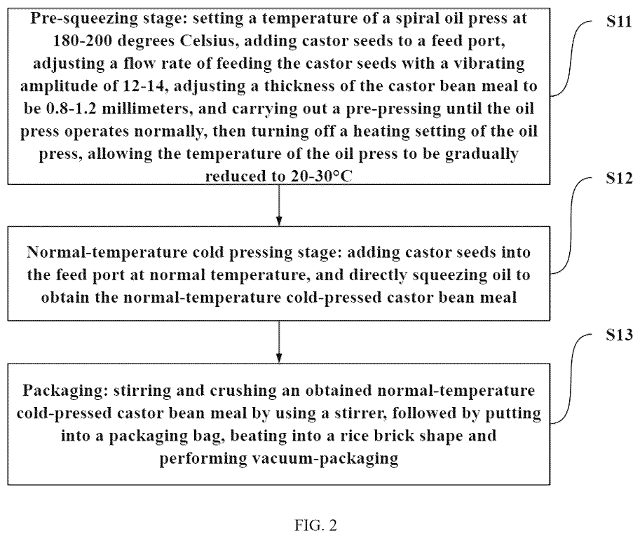

FIG. 3 is a flow chart illustrating S3 of the preparation method of the organic fertilizer of normal-temperature cold-pressed castor bean meal fermented by microbial inoculants.

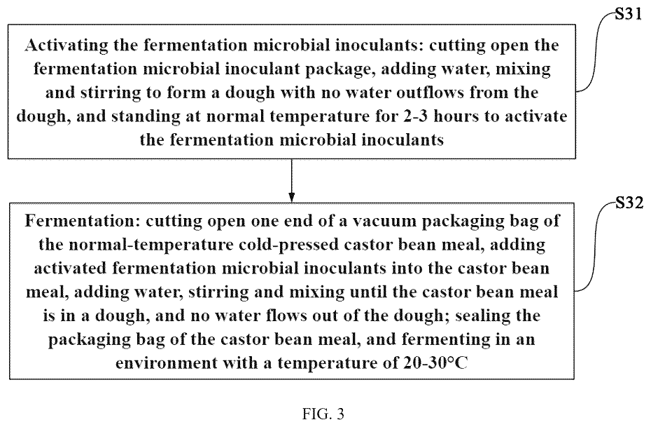

### DETAILED DESCRIPTION OF THE EMBODIMENTS

The technical schemes of the present disclosure are further explained by the attached drawings and embodiments.

Unless otherwise defined, technical terms or scientific terms used in the present disclosure shall have their ordinary meanings as understood by people with ordinary skills in the field to which this present disclosure belongs.

### Embodiment 1

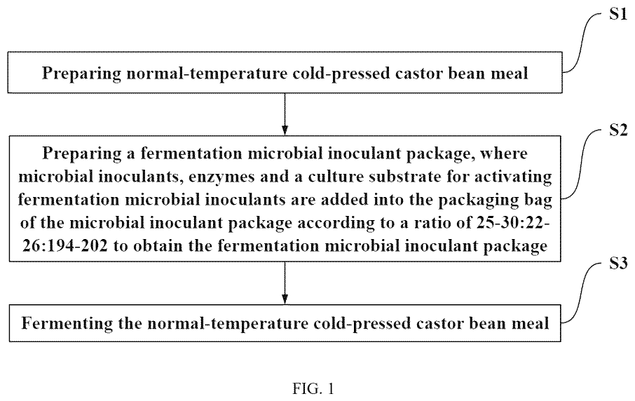

FIG. 1 shows a flow chart of a preparation method of an organic fertilizer of cold-pressed castor bean meal fermented by microbial inoculants, which specifically includes the following steps:
S1, preparing normal-temperature cold-pressed castor bean meal:
S11, pre-squeezing stage: setting a temperature of a spiral oil press at 180-200° C., adding castor seeds to a feed port, adjusting a flow rate of feeding the castor seeds with a vibrating amplitude of 12-14, adjusting a thickness of the castor bean meal to be 0.8-1.2 mm, and carrying out a pre-pressing until the oil press operates normally, then turning off a heating setting of the oil press, allowing the temperature of the oil press to be gradually reduced to 20-30° C.;
S12, normal-temperature cold pressing stage: adding castor seeds into the feed port at normal temperature, and directly squeezing oil to obtain the normal-temperature cold-pressed castor bean meal;
S13, packaging: stirring and crushing the obtained normal-temperature cold-pressed castor bean meal using a stirrer, followed by putting into a packaging bag, beating into a rice brick shape and performing vacuum-packaging;
S2, preparing a fermentation microbial inoculant package, where microbial inoculants, enzymes and a culture substrate for activating fermentation microbial inoculants are added into the packaging bag of the microbial inoculant package according to a ratio of 25-30:22-26:194-202 to obtain the fermentation microbial inoculant package;
where the microbial inoculants include Bacillus, Saccharomycese, photosynthetic bacteria, acetic acid bacteria, lactic acid bacteria, actinomyces and Trichoderma, and a mass ratio is 1:1:1:1:1:1:1;
the enzymes include soil urease, protease, phosphatase, sucrase, catalase, polyphenol oxidase, cellulase and acid invertase in a mass ratio of 1:1:1:1:1:1:1:1; and
the culture substrate for activating the fermentation microbial inoculants is corn flour;
S3, fermenting the normal-temperature cold-pressed castor bean meal:
S31, activating the fermentation microbial inoculants: cutting open the fermentation microbial inoculant package, adding water, mixing and stirring to form a dough with no water outflows from the dough, and standing at normal temperature for 2-3 h to activate the fermentation microbial inoculants;
S32, fermentation: cutting open one end of a vacuum packaging bag of the normal-temperature cold-pressed castor bean meal, adding activated fermentation microbial inoculants into the castor bean meal, adding water, stirring and mixing until the castor bean meal is in a dough, and no water flows out of the dough (normal-temperature cold-pressed castor bean meal: fermentation microbial inoculants: water=4-5 kg: 250-300 g: 800-1000 mL; scaling the packaging bag of the castor bean meal, and fermenting in an environment with a temperature of 20-30° C., where a fermentation duration is 20-30 d, with piles being turned over at intervals of 7 d.

### Embodiment 2

The organic fertilizer prepared in Embodiment 1 is applied to a variety of four-grains redskin peanut, with 10 treatments arranged as follows:
CK: blank control without fertilization;
HF1: chemical fertilizer, NPK is 125-75-50 kg·ha⁻¹ (control);
HF2: chemical fertilizer, NPK is 250-150-100 kg·ha⁻¹ (control);
HF3: chemical fertilizer with NPK of 500-300-200 kg·ha⁻¹ (control);
BM1: castor bean meal fertilizer, 2500 kg·ha⁻¹;
NF1: farmyard manure, 6000 kg· ha⁻¹ (control);
NF2: farmyard manure, 1.2 ton per hektare (t·ha⁻¹) (control); and
NF3: farmyard manure, 2.4 t·ha⁻¹ (control).

Random design is adopted, and each treatment is repeated for 3 times, with a total of 30 plots, each plot has an area of 2.5 meters (m)×2 m, a row spacing of 50 centimeters (cm) and a hole spacing of 10 m. Two seeds are planted in each hole, and the planting density is 13,000 holes/667 m². A protection row of 1 m is set between plots, and other management is the same as that of a large field. All fertilizers are put in one time in the form of bottom fertilizer before planting.

### Embodiment 3

BM2: castor bean meal fertilizer, 5000 kg·ha⁻¹; other management is completely consistent with the Embodiment 2.

### Embodiment 4

BM3: castor bean meal fertilizer, 1 t·ha⁻¹; other management is completely consistent with the Embodiment 2.

The peanut yield traits, peanut quality traits and peanut field improvement effects of Embodiment 2, Embodiment 3, Embodiment 4 and each control group are compared below.

### (1) Effect on Peanut Yield Traits (the Following is the Average Value)

Main root length (cm):
BM3 (16.89)>CK (13.44)>BM2 (13.35)>HF2 (13.24)>NF2 (13.03)>HF1 (12.95)>BM1 (12.67)>NF1 (12.58)>NF3 (11.31)>HF3 (9.91).

Plant height (cm):
BM3 (87.97)>NF1 (67.38)>HF2 (64.91)>HF3 (64.02)>BM2 (58.74)>CK (56.33)>HF1 (5 5.77)>NF3 (55.54)>NF2 (54.50)>BM1 (40.93).

Number of branches (branch):
BM3 (24.28)>HF2 (20.28)>BM2 (17.63)>HF1 (15.66)>NF1 (14.61)>NF2 (14.55)>NF3 (14.09)>CK (13.75)>HF3 (13.63)>BM1 (13.41).

Lateral branch length (cm):
BM3 (92.58)>HF3 (65.83)>NF1 (63.00)>HF2 (57.51)>BM2 (55.34)>NF3 (53.65)>NF2 (49.47)>CK (47.61)>BM1 (45.91)>HF1 (43.36).

Fruit weight per plant (g):
BM3 (24.84)>BM2 (14.53)>HF2 (13.72)>HF1 (12.86)>BM1 (12.84)>HF3 (10.16)>NF1 (9.93)>NF2 (9.88)>NF3 (6.01)>CK (4.93).

Hundred-fruit weight (g):
BM3 (196.67)>BM2 (177.33)>BM1 (169.33)>NF1 (164.00)>HF1 (160.33)=HF3 (160.3 3)>HF2 (158.66)>CK (146.00)>NF3 (144.67)>NF2 (138.67).

Hundred-grains weight (g):
BM1 (49.33)>BM3 (49.00)>NF1 (48.33)>BM2 (47.67)>HF1 (46.67)>HF3 (44.33)>HF2 (44.00)>NF2 (43.33)>NF3 (43.00)>CK (40.33 g).

Yield (fruit weight) (kilograms per hektare (kg/hm²)):
BM3 (4968.11)>BM2 (2907.83)>HF2 (2744.40)>HF1 (2572.21)>BM1 (2569.57)>HF3 (2332.92)>NF1 (1987.06)>NF2 (1977.87)>NF3 (1203.93)>CK (987.57).

Judging from the yield indicators of peanuts, the best in general synthesis is BM3, followed by BM2.

### (2) Effect on Peanut Quality Traits (the Following is the Average Value)

Protein content (g/100 g):
BM1 (19.09)>BM2 (18.26)>BM3 (17.80)>NF1 (17.20)=HF3 (17.20)>HF2 (16.70)>NF2 (16.69)>HF1 (16.36)>NF3 (16.3)=CK (16.64).

Total sugar content (g/100 g):
BM3 (34.80)>CK (34.75)>HF3 (33.29)>BM2 (32.34)>NF1 (32.28)>HF1 (32.21)>NF2 (3 1.87)>NF3 (31.19)>BM1 (30.24)>HF2 (29.27).

Vitamin E content (mg/100 g):
BM1 (202.04)>BM2 (187.94)>CK (185.65)>HF3 (183.13)>HF2 (182.49)>NF3 (182.25)>HF1 (179.66)>BM3 (165.16)>NF2 (165.00)>NF1 (152.09).

Resveratrol content (mg/kg):
BM3 (0.50)>BM2 (0.12)=BM1 (0.12)>NF1 (0.10)>HF2 (0.10)>HF1 (0.09)=CK (0.09)=H F3 (0.09)>NF2 (0.08)=NF3 (0.08).

Generally speaking, the peanuts have similar quality indexes, with BM2 and BM1 being the best, followed by BM3, and the resveratrol content of BM3 is significantly higher than that of BM2 and BM1. i.e. castor bean meal fertilizer is capable of significantly improving the quality of peanuts as compared with chemical fertilizers, cow dung, and no fertilizers.

### (3) Improvement Effect on Peanut Field

### Soil Nutrients

PH value:
BM3 (7.5)<CK (7.9)<BM2 (8.5)=BM1 (8.5)=HF1 (8.5)=HF2 (8.5)<HF3 (8.6)<NF1 (8.7)<NF2 (8.8)=NF3 (8.8).

Organic carbon content (g/kg):
BM3 (18.9)>BM1 (13.8)>BM2 (13.7)>HF2 (13.1)>NF1 (11.9)>HF3 (11.2)>HF1 (10.7)=CK (10.7)>NF3 (9.2)>NF2 (8.7).

Total nitrogen content (g/kg):
BM3 (1.6)>BM2 (0.9)=HF1 (0.9)=HF3 (0.9)=HF2 (0.9)=NF3 (0.9)>BM1 (0.8)=CK (0.8)=NF1 (0.8)>NF2 (0.7)

Total phosphorus content (g/kg):
BM3 (0.5)>BM2 (0.3)=BM1 (0.3)=HF3 (0.3)=HF2 (0.3)=CK (0.3)=HF1 (0.3)=NF1 (0.3)=NF2 (0.3)>NF3 (0.2).

Total potassium content (g/kg):
BM3 (26.0)>BM2 (25.9)>HF3 (25.6)>HF2 (25.4)>BM1 (25.1)=NF1 (25.1)>NF2 (25.0)=NF3 (25.0)>CK (24.6)>HF1 (24.3).

Available nitrogen content (mg/kg):
BM3 (107.9)>BM2 (65.8)>HF3 (64.5)>HF2 (60.6)>BM1 (58.7)>NF2 (58.0)>CK (57.6)>HF1 (52.2)>NF3 (45.0)>NF1 (35.0).

Available phosphorus content (mg/kg):
BM2 (31.1)>BM1 (26.6)>HF3 (26.4)>HF2 (20.0)>NF3 (15.5)>HF1 (15.3)>NF2 (14.6)>CK (12.6)>NF1 (10.0).

Available potassium content (mg/kg):
BM3 (250.0)>HF3 (178.6)>BM2 (154.7)>HF2 (152.4)>HF1 (152.2)>BM1 (138.5)>NF2 (132.0)>NF3 (113.0)>NF1 (112.0)>CK (106.5).

In terms of soil nutrients in peanut field, BM3 is the best, followed by BM2, suggesting that the castor bean meal fertilizer may obviously improve soil nutrients in peanut field.

### Soil Enzyme Activity

Urease activity (u/g):
BM3 (7675.2)>BM2 (3860.0)>HF3 (3556.9)>BM1 (2676.8)>HF2 (2327.4)>CK (2275.2)>HF1 (1771.3)>NF2 (685.9)>NF3 (670.2)>NF1 (538.3).

Phosphatase activity (U/g):
BM3 (2.5)>BM2 (1.7)>BM1 (1.6)=CK (1.6)>HF2 (1.4)=HF3 (1.4)>HF1 (1.2)>NF2 (0.2)>NF3 (0.15)>NF1 (0.1).

Sucrase activity (U/g):
BM3 (33.9)>BM2 (18.8)>BM1 (14.4)>NF1 (13.7)>NF2 (13.6)> (12.9)>HF3 (12.5)>HF2 (11.9)>HF1 (9.3)>CK (8.8).

Catalase activity (U/g):
BM3 (1411.9)>BM2 (910.9)>BM1 (903.3)>CK (890.1)>HF2 (856.1)>NF1 (835.0)>HF1 (822.9)>HF3 (812.9)>NF2 (744.0)>NF3 (631.0).

Acid invertase activity (u/g):
BM3 (29.8)>BM2 (14.9)>BM1 (11.1)=NF3 (11.1)>NF2 (11.0)>NF1 (10.8)>HF3 (9.9)>C K (9.2)>HF2 (8.2)>HF1 (7.7).

Polyphenol oxidase activity (U/g):
BM1 (5.8)>BM2 (5.7)>BM3 (5.3)>HF3 (5.1)>NF3 (5.0)>NF1 (4.8)>HF2 (3.9)>CK (3.8)>NF2 (3.7)>HF1 (3.5).

Protease activity (u/g):
BM3 (2.0)>HF3 (1.8)>BM2 (1.6)=HF2 (1.6)>BM1 (1.5)=CK (1.5)>HF1 (1.4)>NF1 (0.3)=NF2 (0.3)=NF3 (0.3).

Cellulase activity (U/g):
BM3 (3.0)>BM2 (1.6)>BM1 (1.1)>HF3 (1.0)>HF2 (0.9)=NF1 (0.9)>HF1 (0.7)=CK (0.7)=NF2 (0.7)=NF3 (0.7).

In terms of soil enzyme activity in peanut field, BM3 is the best, followed by BM2, indicating that the castor bean meal fertilizer may obviously improve soil enzyme activity in peanut field.

The organic fertilizer of normal-temperature cold-pressed castor bean meal fermented by microbial inoculants may also be used for other economic plants.

Accordingly, by adopting the preparation method of the organic fertilizer of normal-temperature cold-pressed castor bean meal fermented by microbial inoculants and application thereof, the prepared organic fertilizer has higher nutritional value, longer shelf life, shorter fermentation time, better soil improvement effect, no pollution to the soil, and is more conducive to the development of green, organic and ecological agriculture.

Finally, it should be noted that the above embodiments are only used to illustrate the technical scheme of the present disclosure, but not to limit it. Although the present disclosure has been described in detail with reference to the preferred embodiments, ordinary technicians in the field should understand that they can still modify or replace the technical scheme of the present disclosure, and these modifications or equivalent substitutions cannot make the modified technical scheme deviate from the spirit and scope of the technical scheme of the present disclosure.

1. A preparation method of an organic fertilizer of normal-temperature cold-pressed castor bean meal fermented by microbial inoculants, comprising:
S1, preparing normal-temperature cold-pressed castor bean meal:
S11, pre-squeezing stage: setting a temperature of a spiral oil press at 180-200 degrees Celsius, adding castor seeds to a feed port, adjusting a flow rate of feeding the castor seeds with a vibrating amplitude of 12-14, adjusting a thickness of the castor bean meal to be 0.8-1.2 millimeters, and carrying out a pre-pressing until the oil press operates normally, then turning off a heating setting of the oil press, allowing the temperature of the oil press to be gradually reduced to 20-30 degrees Celsius;
S12, normal-temperature cold pressing stage: adding castor seeds into the feed port at normal temperature, and directly squeezing oil to obtain the normal-temperature cold-pressed castor bean meal;
S13, packaging: stirring and crushing an obtained normal-temperature cold-pressed castor bean meal by using a stirrer, followed by putting into a packaging bag, beating into a rice brick shape and performing vacuum-packaging;
S2, preparing a fermentation microbial inoculant package, wherein microbial inoculants, enzymes and a culture substrate for activating fermentation microbial inoculants are added into the packaging bag of the microbial inoculant package according to a ratio of 25-30:22-26:194-202 to obtain the fermentation microbial inoculant package;
S3, fermenting the normal-temperature cold-pressed castor bean meal:
S31, activating the fermentation microbial inoculants: cutting open the fermentation microbial inoculant package, adding water, mixing and stirring to form a dough with no water outflows from the dough, and standing at normal temperature for 2-3 hours to activate the fermentation microbial inoculants; and
S32, fermentation: cutting open one end of a vacuum packaging bag of the normal-temperature cold-pressed castor bean meal, adding activated fermentation microbial inoculants into the castor bean meal, adding water, stirring and mixing until the castor bean meal is in a dough, and no water flows out of the dough; sealing the packaging bag of the castor bean meal, and fermenting in an environment with a temperature of 20-30 degrees Celsius;
wherein in step S32, a ratio of the normal-temperature cold-pressed castor bean meal: fermentation microbial inoculants: water is 4-5 kilograms: 250-300 grams: 800-1000 milliliters.

2. The preparation method of the organic fertilizer of normal-temperature cold-pressed castor bean meal fermented by microbial inoculants according to claim 1, wherein in step S2, the microbial inoculants comprise Bacillus, Saccharomycese, photosynthetic bacteria, acetic acid bacteria, lactic acid bacteria, actinomyces and Trichoderma, and a mass ratio is 1:1:1:1:1:1:1.

3. The preparation method of the organic fertilizer of normal-temperature cold-pressed castor bean meal fermented by microbial inoculants according to claim 1, wherein in the step S2, the enzymes comprise soil urease, protease, phosphatase, sucrase, catalase, polyphenol oxidase, cellulase and acid invertase in a mass ratio of 1:1:1:1:1:1:1:1.

4. The preparation method of the organic fertilizer of normal-temperature cold-pressed castor bean meal fermented by microbial inoculants according to claim 1, wherein in the step S2, the culture substrate for activating the fermentation microbial inoculants is corn flour.

5. The preparation method of the organic fertilizer of normal-temperature cold-pressed castor bean meal fermented by microbial inoculants according to claim 1, wherein in step S3, a fermentation duration is 20-30 days, with piles being turned over at intervals of 7 days.

6. An organic fertilizer of normal-temperature cold-pressed castor bean meal fermented by microbial inoculants prepared by a preparation method of an organic fertilizer of normal-temperature cold-pressed castor bean meal fermented by microbial inoculants.
